(19) United States
(12) Patent Application Publication
(10) Pub. No.: US 2006/0256458 A1
(43) Pub. Date: Nov. 16, 2006

(54) REAR VIEW MIRROR

(76) Inventor: HIERONIM ZMARLICKI, SOUTH WINDSOR, CT (US)

Correspondence Address: ROBERT S. SMITH, 1131-0 TOLLAND TURNPIKE, SUITE 306, MANCHESTER, CT, 06040, US

(21) Appl. No.: 10/908,519

(22) Filed: May 16, 2005

(51) Int. Cl. G02B 5/08

(52) U.S. Cl. 359/868; 359/866

(57) ABSTRACT

A rear view mirror has a single mirror surface. The single mirror surface heads first and second planar reflective portions having an included angle therebetween that is less than 180°. In some cases the mirror is elongated in a direction that is normally horizontal when the mirror is mounted for use and the first and second portions many intersect to define a line that is vertical when the mirror is mounted for use. For some applications an included angle of approximately 160° is preferred. In some cases the first portion is mounted during normal use with the plane thereof substantially normal to the major axis of the vehicle on which the mirror is mounted. For some embodiments, the second portion is to the right of the first portion during normal use. The first portion may be elongated and many more specifically be elongated in a direction that is horizontal during normal use. Similarly, the second portion may be elongated and this elongation may be in a direction that is horizontal during normal use.

### FIELD OF THE INVENTION

The invention relates to rear view mirrors suitable for use on cars, trucks, buses, etc. While the primary application of the invention is for a mirror that is mounted on the windshield, typically near the top central portion of the windshield, those skilled in the art will recognize that some embodiments of the rear view mirror in accordance with the present invention may also be used for bicycles, motorcycles, and a wide range of other applications.

### BACKGROUND OF THE INVENTION

The prior art includes a wide variety of vehicle rear view mirrors. The most common form of rear view mirror that is mounted to the windshield near the top and central portion thereof is a planar reflective surface characterized by the traditional laws of physics wherein the angle of incidence of light is equal to the angle of reflection of light.

Concave and convex mirrors have been widely used for side mirror applications. A major disadvantage of such mirrors is that the user cannot perceive the distance between a first vehicle on which the mirrors mounted and a second vehicle that is approaching the first vehicle from the rear. Smaller mirrors of this type do not allow the user to quickly perceive a vehicle in a blind spot. The failure of such smaller mirrors to facilitate such a quick perception severely compromises the usefulness of such mirrors.

Some prior art aftermarket mirrors intended for installation near the top central portion of the windshield include a plurality of planar face mirrors that are not coplanar. More specifically, such mirrors may include an array of planar mirrors in which each planar mirror in the array is disposed in oblique relationship to each other mirror in the array. Such assemblies tend to be rather large. Smaller mirrors of this type do not allow the user to quickly perceive a vehicle in a blind spot.

### SUMMARY OF THE INVENTION

It is an object of the invention is to provide a simple and inexpensive mirror that will enable a driver to quickly perceive a vehicle in the drivers blind spot.

It is an object the present invention to provide a mirror that is compact and thus will not interfere with the driver's forward vision.

A further object of the present invention is to improve highway safety by reducing actions caused by drivers being unable to see another vehicle in the noted blind spots.

It has now been found that these and other objects of the present invention may be achieved a rear view mirror which includes a single mirror surface. The single mirror surface heads first and second planar reflective portions having an included angle therebetween that is less than 180°.

In some cases the mirror is elongated in a direction that is normally horizontal when the mirror is mounted for use and the first and second portions many intersect to define a line that is vertical when the mirror is mounted for use.

The included angle will always be less than 180° although in some cases it may be less than 170°, 160°, 150° or even 140°. For some applications an included angle of approximately 1 600 is preferred. In some cases the first portion is mounted during normal use with the plane thereof substantially normal to the major axis of the vehicle on which the mirror is mounted. For some embodiments the second portion is to the right of the first portion during normal use. The first portion may be elongated and many more specifically be elongated in a direction that is horizontal during normal use. Similarly, the second portion may be elongated and this elongation may be in a direction that is horizontal during normal use.

### BRIEF DESCRIPTION OF THE DRAWINGS

The invention will be better understood by reference to the accompanying drawing in which:

FIG. 1 is a front elevation view of a prior art rear view mirror.

FIGS. 2 and 3 are diagrammatic representations of the prior art mirror illustrated in FIG. 1 illustrating that the angle on an incident light ray is equal to the angle of a reflected light ray.

FIG. 4 is a diagrammatic view illustrating respectively, in the case of a prior art mirror, the regions the driver can see through the prior art mirror and the blind spots on each side.

FIG. 5 is a diagrammatic representation of the potential for an accident as a result of the blind spots illustrated in FIG. 4.

FIG. 6 is a diagrammatic representation of the rear view mirror in accordance with one form of the present invention.

### DETAILED DESCRIPTION OF PREFERRED EMBODIMENTS

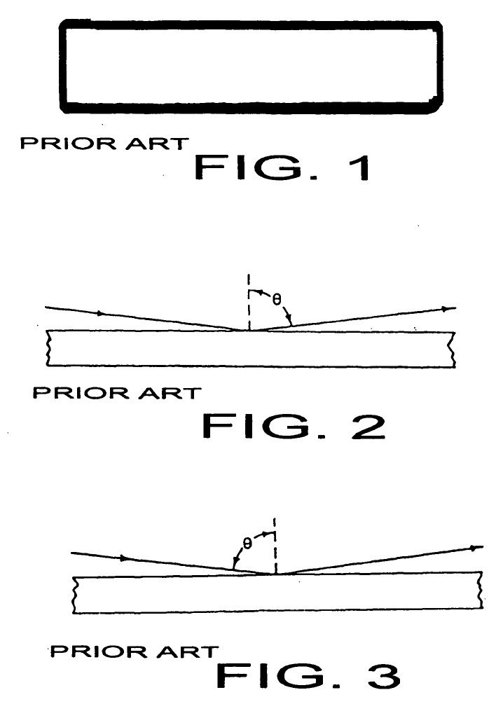

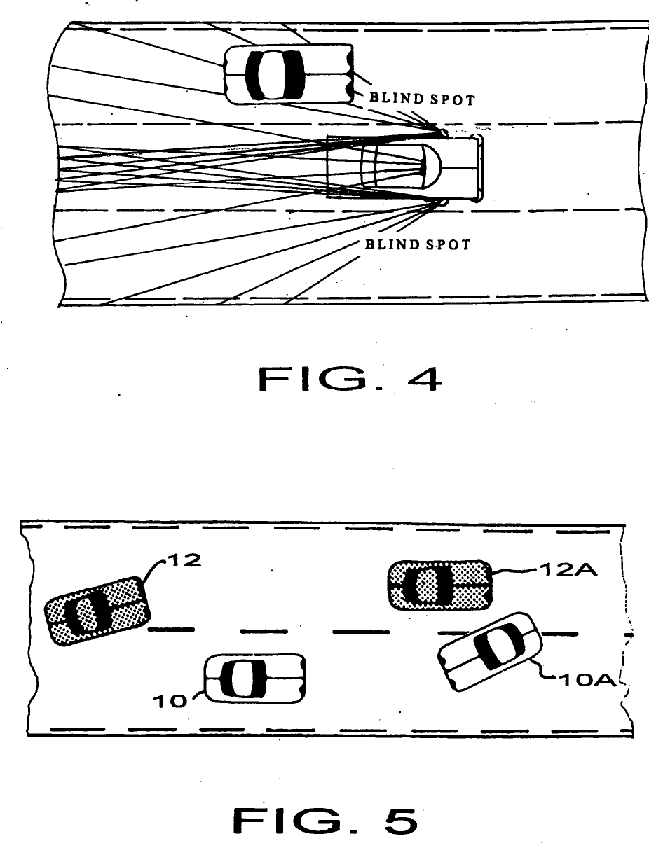

Referring now to FIGS. 1-5 there are shown a prior art rear view mirror in which the angle of incidence of a light ray is equal to the angle of reflection reset of that light ray. As shown in FIG. 4 the driver of a vehicle moving from left to right, as illustrated, can see a tapered zone behind the vehicle. The driver of the vehicle can not see another vehicle located in the blind zones or spots indicated by cross-hatching.

As shown in FIG. 5, the driver of a vehicle 10 cannot see the vehicle 12 located in the blind spot of that driver. Subsequent positions of vehicles 10 and 12 are represented in this diagram by the representations identified as 10A and 12A. The driver of the vehicle 10 may, in reliance on his perceptions of situation utilizing the prior art rear view mirror, attempt to move to the left lane and may impact the other vehicle 12A.

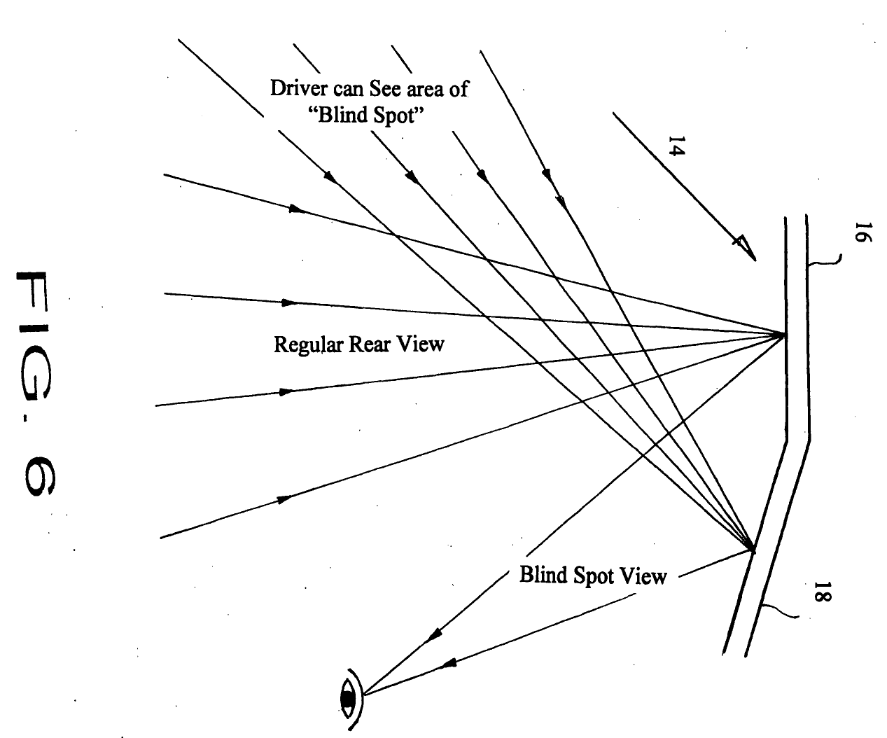

FIG. 6 illustrates diagrammatically one form of the unitary apparatus 14 in accordance with the present invention. This apparatus 14 is a unitary or monolithic mirror that includes a first planar portion 16 and a second planar portion 18. In the preferred embodiment the included angle between the first and second planar portions 14, 18 is about 160°. Other embodiments may have other included angles. Ordinarily, the included angle will be below 180°. The specific angle required will vary with the specific vehicle application. As illustrated in FIG. 6 the first portion 16 provides the conventional rear view mirror image that drivers are accustomed to seeing. The second planar portion 18 provides an image of the zone defined as the blind spot to the left and rear of the driver and the normal driving position. Although the present description of the preferred embodiment includes only first and second portions, other embodiments may include a third planar portion (not shown) disposed to the left of the first plainer portion 16. In such an environment the included angle between the first planar portion 16 and the third planar portion (not shown) will typically be about 160°.

The mirror 14 will ordinarily be elongated. More specifically the mere 14 will be elongated in a direction that is horizontal when installed for normal operation. In addition, each of the portions such as first portion 16 and second portion 18 will be elongated horizontally when installed for normal operation. Similarly, the third planar portion (not shown) will also be elongated horizontally when installed for normal operation.

The mirror 14 will ordinarily be manufactured in accordance with the customary manufacturing procedures. Mirrors are customarily manufactured from a sheet of glass that is coated on its back with aluminum or silver that produce images by reflection. Alternatively, highly polished metal may be used. The mirror 14 will normally be manufactured by providing a sheet of glass, heating the sheet of glass, bending the sheet of glass to define first and second planar portions(or for second and third planar portions), and coating the back of glass with aluminum or silver.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A rear view mirror which comprises:
a single mirror surface;
said single mirror surface having first and second planar reflective portions having an included angle therebetween that is less than 180°.

2. The mirror as described in claim 1 wherein said mirror is elongated in a direction that is normally horizontal when said mirror is mounted for use.

3. The mirror as described in claim 1 wherein said first and second portions intersect to define a line that is vertical when said mirror is mounted for use.

4. The mirror as described in claim 1 wherein said included angle is less than 170°.

5. The mirror as described in claim 1 wherein said included angle is less than 160°.

6. The mirror as described in claim 1 wherein said included angle is less than 150°.

7. The mirror as described in claim 1 wherein said included angle is less than 140°.

8. The mirror as described in claim 1 wherein said included angle is approximately 160°.

9. The mirror as described in claim 1 wherein said first portion is mounted during normal use with the plane thereof substantially normal to the major axis of the vehicle on which the mirrors mounted.

10. The mirror as described in claim 9 wherein said second portion is to the right of said first portion during normal use.

11. The mirror as described in claim 1 wherein said first portion is elongated.

12. The mirror as described in claim 1 wherein said first portion is elongated in a direction that is horizontal during normal use.

13. The mirror as described in claim 1 wherein said second portion is elongated.

14. The mirror as described in claim 1 wherein said second portion is elongated in a direction that is horizontal during normal use.
